(19) United States
(12) Patent Application Publication
(10) Pub. No.: US 2006/0139709 A1
(43) Pub. Date: Jun. 29, 2006

(54) System and method for automatically sorting digital photographs

(76) Inventors: Louis Bifano, Morrisville, PA (US); David T. Horoschak, Doylestown, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/025,028

(22) Filed: Dec. 29, 2004

(51) Int. Cl. H04N 1/23

(52) U.S. Cl. 358/527; 358/302

(57) ABSTRACT

A method for providing for the automatic accurate sorting of digital photograph files, without dependence on a particular application or operating-system, by use of its inventive metadata file is disclosed. The present invention provides a metadata file, containing date and time of capture datum, associated with each digital photograph file. When uploaded to the computer for storage on non-volatile storage, the metadata is transferred along with the digital photograph files. Thereafter, an inventive system of the present invention allows consumers to specify events, and view and/or print digital photograph files which fit the event date criteria by querying the metadata associated with each digital photograph file.

### FIELD OF THE INVENTION

The present invention relates to digital data files. More specifically, the present invention relates to digital photograph files and the organization thereof.

### BACKGROUND OF THE INVENTION

Digital photography has made a tremendous impact in both professional and consumer image capture. The impact is so great that most consumers now prefer to use a digital camera to capture images of family events, holiday affairs, vacations, etc. Of the most significant reasons for consumer migration to the digital domain for photography is (i) the easy of use; (ii) reusable memory; (iii) no need for costly un-reusable film; and (iv) immediate gratification in terms of viewing the resultant photographs on screen on a personal computer, and the easy of creating prints with now available reasonably prices image/photo printers. Further, the resultant photographs can be easily shared with others by sending them via e-mail or posting them on an Internet server. To make picture taking even more convenient, and part of one's life, camera functionality has even been integrated into many other commonly used consumer devices, such as wireless/cellular telephones, personal digital assistants (“PDA”), etc.

As a result of the above recited advantages and conveniences, consumers generally shot hundreds more pictures than were common when shooting solely in the analog domain. With the increased number of resultant photographs, each being a file and stored on a hard drive (whether internal or external) to a personal computer, a problem exists in the organization of these countless photographs.

Currently, a consumer can spend numerous hours organizing digital photograph files using standard directory structures found with most operating systems. A consumer may even find a software application that creates a proprietary index to assist in digital photograph sorting, but only if the photographs were imported (from the camera to the computer) through such software application. However, such index is not portable to other applications, and serves the consumer no use when outside of the index creating software application. Further, such a proprietary index generally ties each digital photograph file to the date it was uploaded to the computer, not the actual image capture date. Hence, if you took pictures spanning three (3) calendar days and uploaded all digital photograph files to the computer on a fourth calendar day, index creating digital photograph file importing applications would associate pictures of all three days with one day, which would be the “upload day”.

What is needed is an application and operating-system independent system and method which provides for the automatic accurate sorting of digital photograph files.

### SUMMARY OF INVENTION

An object of the present invention is to provide for the automatic accurate sorting of digital photograph files without dependence on a particular application or operating-system. A further object of the present invention is to provide a system which allows consumers to specify events, and view and/or print digital photograph files which fit the event date criteria.

In order to achieve these objectives, as well as others which will become apparent in the disclosure below, the present invention provides a metadata file associated with each digital photograph file, where the metadata file contains date and time datum of the image captured in the associated digital photograph file.

In an exemplary embodiment of the present invention, when digital photographs are capture by a digital camera, the actual date and time for the image capture is encapsulate in a metadata file associated with the digital photograph file (“DPF”). When uploaded to the computer for storage on non-volatile storage, e.g., hard drive, the metadata is transferred along with the DPF. Thereafter, an inventive system of the present invention allows consumers to specify events, and view and/or print DPFs which fit the event date criteria by querying the metadata associated with each DPF.

Thus, the present method provides for the automatic accurate sorting of digital photograph files, without dependence on a particular application or operating-system, by use of its inventive metadata file. Further, the present system allows consumers to specify events, and view and/or print DPFs which fit the event date criteria by querying the metadata associated with each DPF.

### BRIEF DESCRIPTION OF THE DRAWINGS

For a complete understanding of the present invention and the advantages thereof, reference is now made to the following description taken in conjunction with the accompanying drawings in which like reference numbers indicate like features, components and method steps, and wherein:

FIG. 1 is a prior art illustration of a conventional system for the uploading of DPFs from a digital camera to a personal computer or media server;

FIG. 2 is a flow diagram showing the basic process flow for the automatic accurate sorting of DPFs in accordance with an exemplary embodiment of the present invention;

FIG. 3 is a flow diagram showing the basic process flow for the inventive system and method for allowing consumers to specify events, and view and/or print DPFs which fit the event date criteria by querying the metadata associated with each DPF in accordance with an exemplary embodiment of the present invention; and

FIG. 4 is an illustration of a screen shot for the inventive system of FIG. 3.

### DESCRIPTION OF A PRESENTLY PREFERRED EMBODIMENT

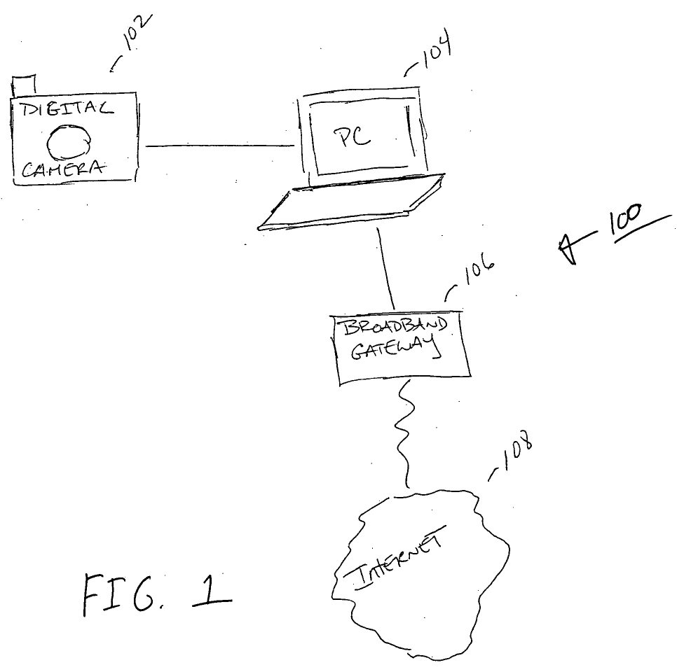

Referring to FIG. 1, system 100 is shown. System 100 is a conventional system for uploading DPFs from a digital camera to a personal computer or media server. System 100 includes a digital camera 102, a personal computer (“PC”) 104, and a broadband interface 106. Here, PC 104 is inclusive of a computer system, media server, and any other device capable of receiving and storing DPFs. Further, it is assumed that PC 104 contain at least one non-volatile storage, such as a hard drive (internal or external), magneto-optical drive, CD-RW drive, DVD-RW drive or FLASH memory, for example. Digital camera 102 is inclusive of all devices which have integrated digital cameras. Such devices included camera enabled personal digital assistants (“PDA”), camera enabled wireless/cellular telephones, etc.

In short, digital camera 102 is used by an end user to capture images which result in DPFs. These DPFs are conventionally uploaded to a PC 104 for storage and later retrieval for viewing on screen; printing; or transfer to others via e-mail over the Internet 108 or via Internet website posting, by means for broadband gateway 106. The above illustrated conventional system 100 does not provide any means for an application and operating system independent method for the automatic accurate sorting of DPFs.

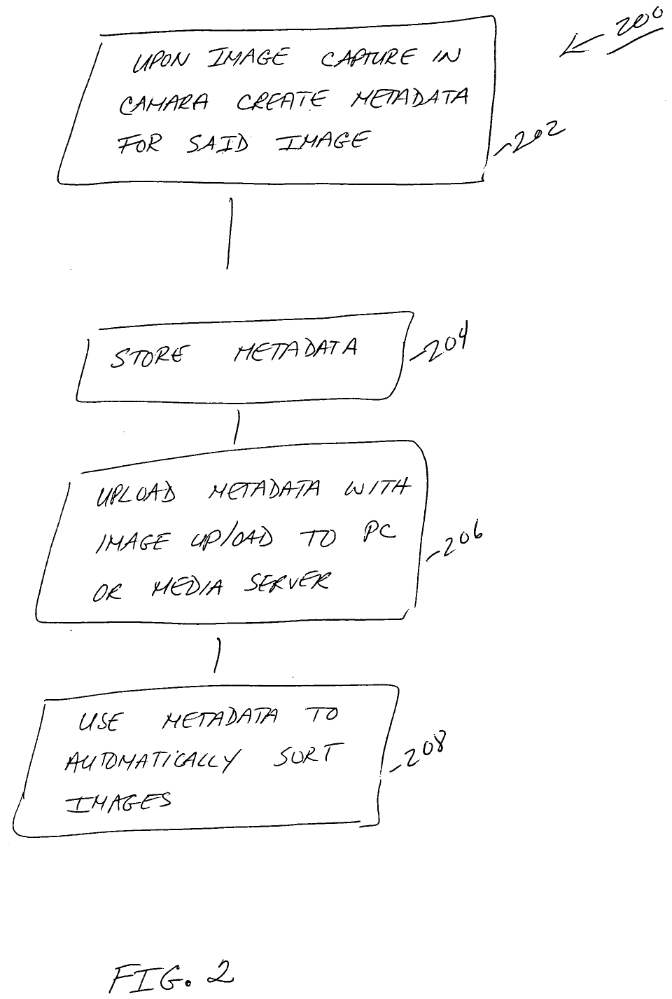

Referring to FIG. 2, in accordance with an exemplary embodiment of the present invention, in operation, upon the capture of an image, digital camera 102 creates a date and time datum for each image captured, in step 202. The digital camera 102 then stores the date and time datum as metadata associated with a DPF file, which contains the actual data for the image/picture taken, in step 204. A DPF may of the format JPEG or BMP, for example. The metadata is stored an easily identifiable associated file. For example, if an image captured (picture) is give a DPF name of “DMC012456.jpg” then the associated metadata file would be similarly named file with a different extension, for example, “DMC012456.met”.

When digital camera 102 is interconnected to PC 104 for upload, the metadata files, e.g., “.met” files, are uploaded with their associated DPFs, in step 206. Application software in PC 104 may then use the metadata to automatically sort the uploaded DPFs by date and even by date and time using the metadata, in step 208. Most significantly, DPFs and their associated inventive metadata files allow for sorting of DPFs by any software application by using date and time datum, independent of which software application was used to import the DPFs in the first instance, and independent of any operating system or file structure of PC 104.

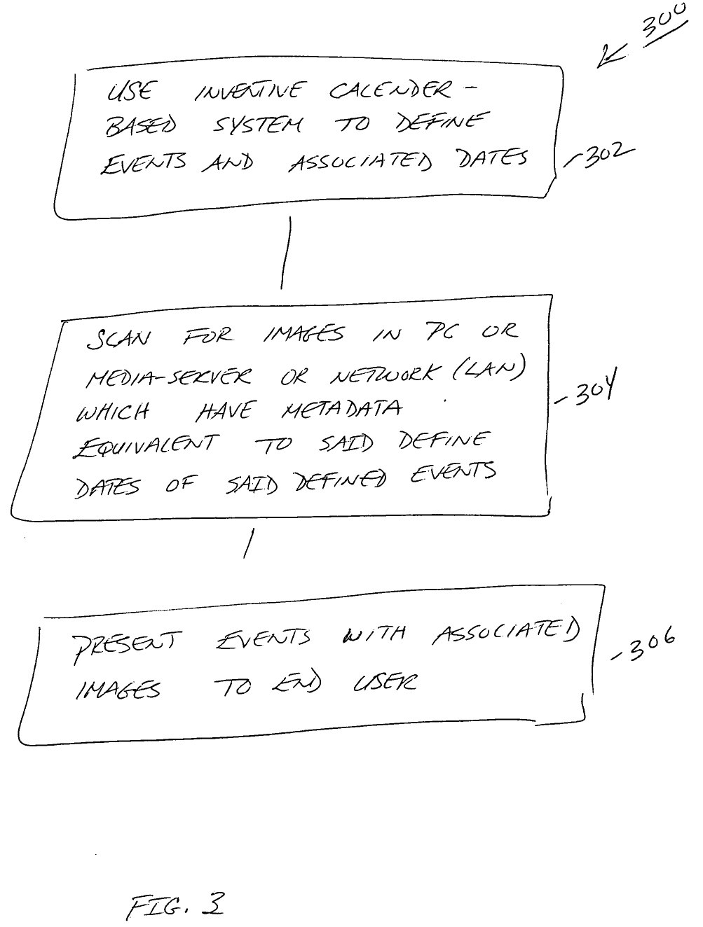

Referring to FIG. 3, the present invention also provides for an inventive calendar based DPF automatic sorting system and method. In accordance with an exemplary embodiment of the present invention, the calendar-based system preferable resides on PC 104. Events are defined by date, or date and time/“time range”, by an end user in the calendar-based system, in step 302. Examples of such events are birthdays, anniversaries, etc. The calendar-based system then scan storage devices, e.g., hard drives, FLASH memory, etc., in PC 104, and optionally other available network (local area network) storage devices for metadata associated with DPFs, in step 304. Using the metadata, the calendar-based system then presents events with associated images (DPFs) to the end user.

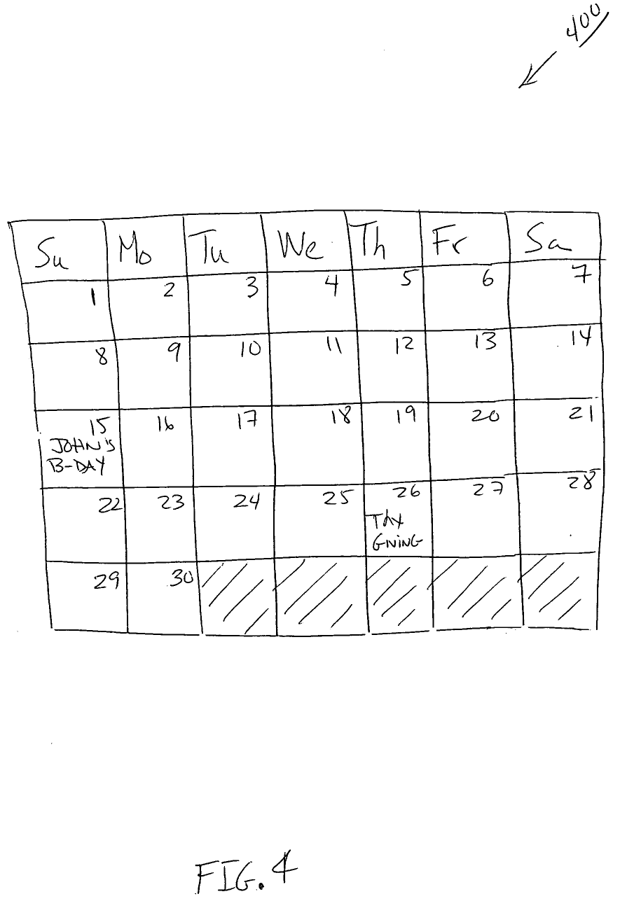

Referring to FIG. 4, the inventive calendar-based system, using the metadata of the present invention, may be manifested in a graphical user interface (“GUI”) which resembles a traditional calendar. A screenshot of the inventive calendar-based system for November 2004 is depicted in FIG. 4, for example. Here, an end user would enter events on the day each event occurs, e.g., “John's Birthday” on the 15^{th}, for example. Further, based upon region, the inventive calendar-based system could provide pre-defined events, e.g., U.S. Thanksgiving Day” on the 26^{th}. After events are defined and/or upon the upload of new DPFs from digital camera 102, an engine in the inventive calendar-based system automatically searches and sorts available DPFs by using the metadata files, so that thereafter an end user can simply click (single or double click) on a date in the calendar GUI of FIG. 4 and be displayed all pictures (DPFs) associated with an event on that day which are in the storage of PC 104, or other accessible DPFs on the LAN of PC 104. If multiple events occur on the same day, time delimitation can be used since (i) the time datum has been encapsulated in the metadata and (ii) time can be defined in the event definition. Further, if an end user wishes to share a DPF with another (transferee), as long as the metadata file is transferred with the associated DPF, the transferee will also be able to have automatic DPF sorting in accordance with the present invention.

Thus, the present method provides for the automatic accurate sorting of digital photograph files without dependence on a particular application or operating-system. Further, the present invention provides a system and method which allows consumers to specify events, and view and/or print DPFs which fit the event date criteria by querying the metadata associated with each DPF.

Although the invention has been described herein by reference to an exemplary embodiment thereof, it will be understood that such embodiment is susceptible of modification and variation without departing from the inventive concepts disclosed. For example, the metadata files need not use the extension “.met”, but rather can use any extension or file name, so long as an association can by made with the correct corresponding DPF. All such modifications and variations, therefore, are intended to be encompassed within the spirit and scope of the appended claims.

We claim:

1. A method for the automatic sorting of digital photograph files, said method comprising:
creating date and time datum for an image upon capture by a digital camera; and
storing said date and time datum as a metadata associated with a digital photograph file containing said image.

2. The method of claim 1 further comprising the step of uploading said digital photograph file with said associated metadata after said step of storing.

3. The method of claim 2 further comprising automatically sorting a plurality of said digital photograph files using said associated metadata for each digital photograph file after said step of uploading.

4. The method of claim 3 further comprising the step of defining at least one calendar date for an image capture event.

5. The method of claim 3 further comprising the step of defining at least one calendar date and time for an image capture event.

6. The method of claim 4 further comprising the step of automatically sorting said digital photograph files, using said associated metadata for each digital photograph file, by events using said at least one calendar date.

7. The method of claim 5 further comprising the step of automatically sorting said digital photograph files, using said associated metadata for each digital photograph file, by events using said at least one calendar date and time.

8. A calendar based system for the automatic sorting of digital photograph files, said system comprising:
a calendar graphical user interface, said interface being used to define at least one event date; and
an engine, said engine searching for metadata associated with digital photograph files, said metadata containing date datum from a capture of an image in said digital photograph file, said engine sorting said digital photograph files by using associated metadata and said at least one defined event date.

9. The system of claim 8, wherein said at least one defined event date further comprise time datum.

10. The system of claim 8, wherein said metadata further comprises time datum.

11. The system of claim 8, wherein said metadata comprises a metadata file having a file name the same as an associated digital photograph file, but having a different file extension.

12. The system of claim 8, wherein at least one defined event date comprise at least one pre-defined holiday based upon geographic region.
